(19) United States
(12) Patent Application Publication
(10) Pub. No.: US 2019/0269141 A1
(43) Pub. Date: Sep. 5, 2019

(54) BAKED FOOD PRODUCED FROM ASTAXANTHIN-CONTAINING DOUGH

(71) Applicant: Fuji Chemical Industry co., Ltd., Toyama-Ken (JP)

(72) Inventors: Yuri Ooi, Kamiichi-machi (JP); Akitoshi Kitamura, Kamiichi-machi (JP); Eiji Yamashita, Kamiichi-machi (JP)

(21) Appl. No.: 16/149,312

(22) Filed: Oct. 2, 2018

Related U.S. Application Data
(63) Continuation of application No. 15/836,375, filed on Dec. 8, 2017, now abandoned.
Application No. 15/836,375 is a continuation of application No. 13/695,371, filed on Jan. 3, 2013, now abandoned.

(30) Foreign Application Priority Data
Apr. 30, 2010 (JP) 2010-105592

(51) Int. Cl. A21D 13/40; A21D 2/32; A21D 13/047; A23L 33/145; A23L 33/135; A23L 33/105; A23G 1/42; A21D 13/045; A21D 2/16; A21D 2/36; A21D 2/34

(52) U.S. Cl. CPC A21D 13/40; A21D 2/32; A21D 13/047; A23L 33/145; A23L 33/135; A23L 33/105; A23V 2250/202; A21D 13/045; A21D 2/165; A21D 2/36; A21D 2/34; A23V 2002/00; A23G 1/423

(57) ABSTRACT

Disclosed is a baked food which comprises a cereal flour, an oil or fat component, astaxanthin and optionally an emulsifying component, has such a structure that the oil or fat component containing the astaxanthin is held in voids in a structure formed by a starch of the cereal flour, and has a porosity of 10 to 70%. Specifically disclosed is a baked food produced from an astaxanthin-containing dough, which can stably hold astaxanthin therein for a long period.

### REFERENCE TO THE RELATED APPLICATION

This application is a continuation of U.S. patent application Ser. No. 13/695,371, filed Jan. 3, 2013, which represents the national stage entry of PCT International Application No. PCT/JP2011/060439, filed on Apr. 28, 2011 and claims the benefit of Japanese Patent Application No. 2010-105592 filed on Apr. 30, 2010, each of which is incorporated herein by reference in their entirety.

### TECHNICAL FIELD

### Field of the Invention

The present invention relates to a baked food produced from an astaxanthin-containing dough, particularly a baked food produced from an astaxanthin-containing dough, which can stably hold astaxanthin therein for a long period.

### Background Art

Recently, astaxanthin draws attention to its various functions including the promotion of health. Astaxanthin is a kind of carotenoid, which is widely distributed in natural products including crustaceans such as lobsters and crabs, fishes such as salmons and sea breams, algae such as green algae hematococcus, and yeasts such as red yeast phaffia, and is used as a red pigment. Astaxanthin is known to have an antioxidative effect in a living matter (Japanese Patent Laid-Open Publication Nos. H02-49091 and 2008-110942), a stress improvement effect (Japanese Patent Laid-Open Publication No. H09-124470) and an effect for improving the damage of a muscle or diseases (Japanese Patent Laid-Open Publication No. 2001-514215).

However, astaxanthin itself is not always to have good taste and is desired to make the one which may be ingested everyday with ease and whets appetite from its appearance. In order to ingest astaxanthin easily and without feeling uncomfortable at dinner, during exercise or as a snack, it is contemplated for astaxanthin to be ingested in the form of a nutritional food or as a favorite beverage.

However, astaxanthin in the intact form is known to be unstable and is described to be readily decomposed at high temperature (Japanese Patent Laid-Open Publication No. H08-012896). Furthermore, it is also indicated in Japanese Patent Laid-Open Publication No. 2002-348275 that pulverized astaxanthin is unstable at room temperature.

It has been described in Japanese Patent Laid-Open Publication No. 2002-348275 that the astaxanthin included in cyclodextrin is incorporated in beverages (including cookies) as the beverages containing astaxanthin. Japanese Patent Laid-Open Publication No. 2008-110942 also discloses antioxidative compositions in which zinc and selenium are incorporated with astaxanthin pulverized by spray drying, and a biscuit is described as one of the preparation example. However, no descriptions on the incorporation of an oil or fat component or an emulsifying component are found and pulverized astaxanthin is used for stabilization in these literatures. In addition, no descriptions are found in these literatures on the stabilization of astaxanthin in beverages for a long period.

Breads containing astaxanthin is disclosed by Y. Ohi et al. (Nippon Shokuhin Kagaku Kogaku Kaishi, Vol 56, 11, 579-584), in which the effects of astaxanthin on the physical properties of the breads have been confirmed. However, as is understood from most of the porosities of commercial crackers and cookies being in the range of 60 to 70%, the breads have a very high porosity, which is obviously different from that of the present invention. Furthermore, the long-term preservation stability of astaxanthin has not been described or suggested in this literature, as is understood from the literature which relates to the effects of astaxanthin on the physical properties of the breads.

No baked food produced from astaxanthin-containing dough, which can stably hold astaxanthin for a long period, has been reported as far as the present inventors know.

### SUMMARY OF THE INVENTION

The present inventors have now succeeded in preparing a baked food produced from astaxanthin-containing dough, which can stably hold astaxanthin therein for a long period including on and after baking. While they believed that astaxanthin itself might be highly likely to be decomposed by heating as described above, surprisingly, astaxanthin was scarcely decomposed even by baking.

More surprisingly, it has been found that astaxanthin contained in the baked food produced from dough thus obtained was decomposed scarcely and was held at a high level even after the long-term preservation of the baked food produced from dough. Then, on the occasion of preparing the baked food produced from dough, an oil extract of astaxanthin was used as the astaxanthin, which was thoroughly kneaded and dispersed into the mixture of raw material components, and the dough thus obtained was baked. On the other hand, when a chocolate containing astaxanthin was prepared, the astaxanthin could not been stably held for a long period in the chocolate obtained. Thus, it has been believed that when a baked food is obtained by using not only the relationship between astaxanthin and an oily substance but also the astaxanthin, a cereal flour, an oil or fat component and optionally an emulsifying component and appropriately kneading these components, astaxanthin could be stably held in the food for a long period.

The present invention is based on these findings.

Thus, the object of the present invention is to provide a baked food produced from astaxanthin-containing dough, which can stably hold astaxanthin therein for a long period.

That is to say, according to the present invention, there are provided the following inventions:
(1) A baked food produced from dough, which is capable of stably holding astaxanthin therein for a long period,

comprising a cereal flour, an oil or fat component and astaxanthin, and having a porosity in the range of 10 to 70%.
(2) A baked food produced from dough according to (1) described above, which further comprises an emulsifying component.
(3) A baked food produced from dough according to (1) or (2) described above, which is capable of holding astaxanthin therein in an amount of 90% by weight or more on the basis of the astaxanthin content in the food immediately after baking at a room temperature condition for a period of at least 3 months to 1 year.
(4) A baked food produced from dough according to any one of (1) to (4) described above, wherein the astaxanthin is any one of an oil extract of astaxanthin, an cell wall debris of algae hematococcus or a yeast phaffia debris.
(5) A baked food produced from dough according to any one of (1) to (4) described above, wherein the cereal flour is at least one selected from the group consisting of wheat flour, soy flour, rice flour, corn flour, barley flour, rye flour, oat flour, potato flour, bean curd lees powder and cornstarch.
(6) A baked food produced from dough according to any one of (1) to (5) described above, wherein the oil or fat component is at least one selected from the group consisting of butter, shortening, margarine, lard, egg oil, rapeseed oil, soybean oil, corn oil, copra oil, palm oil, safflower oil, cottonseed oil, sesame oil, olive oil, camellia oil, rice oil and coconut oil.
(7) A baked food produced from dough according to any one of (2) to (6) described above, wherein the emulsifying component is at least one selected from the group consisting of egg, lecithin, lysolecithin, saponin, glycerine fatty acid ester, sucrose fatty acid ester, sorbitan fatty acid ester and propylene glycol fatty acid ester.
(8) A baked food produced from dough according to any one of (1) to (7) described above, wherein the blending ratio (based on weight) of a cereal flour and an oil or fat component is in the range of the cereal flour: the oil or fat component=100:0.1 to 150.
(9) A baked food produced from dough according to any one of (2) to (8) described above, wherein the blending ratio (based on weight) of a cereal flour and an emulsifying component is in the range of the cereal flour: the emulsifying component=0.1 to 10.
(10) A baked food produced from dough according to any one of (1) to (9) described above, wherein the blending ratio (based on weight) of astaxanthin to the total amount of a cereal flour, an oil or fat component and an emulsifying component is in the range of 100:0.0001 to 1.
(11) A baked food produced from dough according to any one of (1) to (10) described above, which has a structure for holding an astaxanthin containing oil or fat component in voids having a spongy structure formed from starch of a cereal flour.
(12) A method for preparing a baked food produced from dough according to any one of (1) to (10) described above, which comprises astaxanthin, a cereal flour, an oil or fat component and optionally an emulsifying component as the major components, and is capable of stably holding astaxanthin therein for a long period, wherein

the dough is prepared by blending and thoroughly kneading the major components so that the astaxanthin is uniformly dispersed in the mixture of the major components, and then the dough is baked.

In addition, the following inventions are provided according to the other embodiments of the present invention:
(1′) A baked food produced from astaxanthin-containing dough comprising a cereal flour, an oil or fat component and astaxanthin, which is capable of stably holding astaxanthin for a long period.
(2′) A baked food produced from dough according to (1′) described above, which further comprises an emulsifying component.
(3′) A baked food produced from dough according to (1′) or (2′) described above, which has a structure for holding an astaxanthin containing oil or fat component in a spongy structure formed from starch of a cereal flour.
(3″) A baked food produced from dough according to any one of (1′) to (3′) described above, which is obtained by kneading astaxanthin, a cereal flour, optionally an emulsifying component to a sufficient degree for dissolving the astaxanthin and to a sufficient degree for forming a spongy structure to prepare a dough, which is then baked.

According to the present invention, a baked food produced from an astaxanthin-containing dough, which can stably hold astaxanthin in the food for a long period, can be provided. The baked food produced from dough of the present invention contains astaxanthin, and thus the effects which may be anticipated by astaxanthin including antioxidative effect in a living body, stress improvement, improvements of muscle damage or diseases can be anticipated by the ingestion of astaxanthin. Furthermore, the baked food produced from dough according to the present invention contains astaxanthin and in the same time has a form which may be easily ingested everyday, so that it is easily accepted by consumers who wish to ingest astaxanthin in a simple and easy method everyday.

### BRIEF DESCRIPTION OF THE DRAWINGS

FIG. 1 represents the results of the long term stability in Example 1.

FIG. 2 represents the results of the long term stability in Example 2.

FIG. 3 represents the results of the long term stability in Example 5.

FIG. 4 is an electron micrograph of a baked food produced from dough containing butter and egg in Example 2.

FIG. 5 is an electron micrograph of a baked food produced from dough containing neither butter nor egg in Example 2.

FIG. 6 shows the X-RD charts of the baked foods produced from dough containing butter and egg and containing neither butter nor egg in Example 2 and of a wheat flour.

### DETAILED DESCRIPTION OF THE INVENTION

### Baked Food Produced From Dough

The baked food produced from dough of the present invention comprises, as described above, a cereal flour, an oil or fat component and/or emulsifying component and astaxanthin. Thus, as regards the oil or fat component and the emulsifying component, either one or both of them are contained. The baked food produced from dough preferably contains both of the oil or fat component and the emulsifying component.

In addition, the baked food produced from dough of the present invention is capable of stably holding astaxanthin in a food for a long period.

The phrase “capable of stably holding astaxanthin in a food for a long period” means that the astaxanthin can be held in the food in an amount of 90% by weight or more, preferably 94% by weight or more in comparison to the astaxanthin content in the food immediately after baking under the room temperature condition for the period of at least 3 months to 1 year after baking the food.

### Astaxathin

The term “astaxanthin” in the present invention means the one which is derived from natural products or obtained by synthetic methods. The astaxanthin derived from natural products includes those obtained from shells, eggs and tissues of crustaceans such as prawns, euphausiid and crabs, skins and eggs of a variety of fishes, algae such as green algae hematococcus, yeasts such as red yeast phaffia, marine bacteria, seed plants such as Amur adonis and Calendula officinalis. Extracts of the natural products and chemically synthesized products are commercially available and can be obtained easily.

Astaxanthin is 3,3′-dihydroxy-β,β-carotene-4,4′-dione and has stereoisomers. Specifically, three stereoisomers (3R,3′R)-astaxanthin, (3R,3′S)-astaxanthin and (35,3′S)-astaxanthin are known, and any one of these isomers can be used in the present invention.

Mutagenicity is not observed in astaxanthin, which is known to be a compound having a high safety and is generally used as a food additive (Jiro Takahashi: Toxicity test of astaxanthin in algae hematococcus—Ames test, single dose toxicity test in rats, ninety-day repeat dose oral toxicity test in rats, J. Chem. Therap. Med., 20: 867-881, 2004).

In the present invention, astaxanthin involves the free, monoester and diester forms of astaxanthin.

In the baked food produced from dough of the present invention, at least one of the free, monoester and diester forms of astaxanthin can be used. The diester form is physically more stable than the free or monoester form and is scarcely decomposed oxidatively, since the two hydroxyl groups of the diester form are protected by ester bondings. However, it is believed that the diester form, if incorporated in a living body, is promptly hydrolyzed by an enzyme in the living body into the free astaxanthin, which exerts the effect.

The monoester form of astaxanthin includes esters esterified by lower or higher saturated fatty acids or lower or higher unsaturated fatty acids. The specific examples of the lower or higher saturated fatty acids or lower or higher unsaturated fatty acids include acetic acid, lauric acid, myristic acid, pentadecanoic acid, palmitic acid, palmitoleic acid, heptadecanoic acid, elaidic acid, ricinoleic acid, petroselinic acid, vaccenic acid, eleostearic acid, punicic acid, licanic acid, parinaric acid, gadolic acid,5-eicosenic acid, 5-docosenic acid, cetolic acid, erucic acid, 5,13-docosadienic acid, selacholeic acid, decenoic acid, STERING ACID, dodecenoic acid, oleic acid, stearic acid, eicosaopentaenoic acid, docosahexaenoic acid, linoleic acid, linolenic acid, arachidonic acid, and the like. In addition, the diesters of astaxanthin include diesters esterified by the same or different fatty acids selected from group consisting of the fatty acids described above.

Moreover, the monoesters of astaxanthin include amino acids such as glycine and alanine; monovalent or polyvalent carboxylic acids such as acetic acid and citric acid; inorganic acids such as phosphoric acid and sulfuric acid;

saccharides such as glucoside; sugar fatty acid esters such as glycerosugar fatty acid esters and sphingosugar fatty acid esters; fatty acids such as glycerofatty acids; and monoesters esterified by glycerophosphoric acid and the like. In this connection, the salts of the monoesters are also included, if possible.

The diesters of astaxanthin include the ones esterified by the same or different acids selected from the group consisting of the lower saturated fatty acids, the higher saturated fatty acids, the lower unsaturated fatty acids, higher unsaturated fatty acids, amino acids, monovalent or polyvalent carboxylic acids, inorganic acids, sugars, sugar fatty acids, fatty acids and glycerophosphoric acid.

In this connection, the salts of the diesters are also included, if possible. The diesters of glycerophosphoric acid include the satisfied fatty acid esters of glycerophosphoric acid, and glycerophosphoric acid esters containing fatty acids selected from higher unsaturated fatty acids, unsaturated fatty acids or satisfied fatty acids.

In the present invention, either astaxanthin obtained from natural sources or by synthetic methods can be used, but the one derived from natural sources, in which astaxanthin is dissolved in various oil or fat components, is preferred from the viewpoint of the absorption in a body. The astaxanthins obtained from natural sources include, for example, euphausiid extract, phaffia yeast extract and algae hematococcus extract, and the particularly preferred one is the algae hematococcus extract from the viewpoint of the stability of astaxanthin and the kinds of astaxanthin esters

Above all, “AstaREAL” (trade mark; Fuji Chemical Industry Co., Ltd.) is the most preferred from the standpoint of stability and absorbability.

The algae hematococcus is a green alga which belongs to Chlamydomonadaceae, Volvocales. Generally, it is a green alga having a high content of chlorophyll and appearing green, and swims in water with two flagella. However, it forms dormant spore under starvation conditions such as nutritional deficiency or temperature change, increases the astaxanthin content and forms a red sphere. While hematococcus in any condition can be used in the present invention, the hematococcus which has formed dormant spore containing a much amount of astaxanthin is preferably used. Furthermore, in the green algae belonging to the hematococcus genus, Haematococcus pluvialis is preferred.

As the method for culturing the green alga hematococcus, culture methods with a hermetically sealed fermenter, in which different kinds of microorganisms are not contaminated or proliferated and the other impurities are not contaminated, are preferred, and culture methods, for example, by using a fermenter of a partially open dome, cone or cylindrical shape and a culture medium having a gas discharging equipment freely movable in the apparatus (International Publication No. 99/50384), by placing a light source in a hermetically sealed fermenter and irradiating light from the inside of the fermenter, and by using a plane fermenter or a tube type fermenter are suitable.

The methods for obtaining an extract from alga hematococcus of the present invention include:

(1) a method for obtaining the hematococcus extract by drying and crushing hematococcus before supercritical extraction with carbon dioxide as an extraction solvent and then removing carbon dioxide, and

(2) a method for obtaining the hematococcus extract by suspending hematococcus (wet powder) in an organic solvent, then passing the suspension through a pulverizer to pulverize and extract the cells, and removing the organic solvent.

The extraction method by supercritical extraction can be carried out by the usual methods, for example, by the method of Hirose et al. (Ind Eng Chem

Res, 2006, 45(10), 3652-3657, Extraction of Astaxanthin from Haematococcus pluvialis Using Supercritical CO2 and Ethanol as Entrainer).

A variety of methods are known as for the extraction method with an organic solvent. For instance, astaxanthin and its esters are oil soluble materials, and thus astaxanthin-containing ingredients can be extracted from astaxanthin-containing natural products with oil soluble organic solvents such as acetone, alcohols, ethyl acetate, benzene and chloroform. Furthermore, the supercritical extraction method can also be carried out with carbon dioxide and water. After extraction, a mixed concentrate of an astaxanthin monoester and an astaxanthin diester can be obtained by removing the solvent according to the usual method.

The concentrate thus obtained can be further purified, if desired, with a separation column or by lipase degradation.

The method for extracting astaxanthin by drying the alga hematococcus cultured in the dome-shaped fermenter or the hermetically sealed fermenter described above, acetone extraction after pulverization or simultaneous pulverization and extraction with acetone and removing acetone is suitable, because the astaxanthin is scarcely exposed to air and thus little oxidized, contains little impurities, that is, little substances which inhibit the effect of the present invention and thus the extract can contain high purities of astaxanthin and triglyceride in large amounts (Japanese Patent Laid-Open Publication No. 2006-70114).

As the form of use of astaxanthin, the extracts of astaxanthin obtained by the method described above and the powder, aqueous solution or oily solution containing the extracts, or the dry products of red yeast phaffia, algae hematococcus, marine bacteria or the debris thereof such as can be used. According to the preferred embodiment of the present invention, astaxanthin is the oil extract of astaxanthin or the debris of the cell wall of algae hematococcus, as described above.

### Cereal Flour

In the present invention, cereal flour is the powder derived from plants containing starch particles, contains the cereal flour or starch obtained from the cereal flour, and the cereal flour, for example, said cereal flour, includes wheat flours (weak flour, medium-strength flour, strong flour, whole wheat flour and the like), soy flour, rice flour, bean curd lees powder, corn flour (cornstarch), barley flour, duram wheat flour, rye flour, oat flour, oatmeal, germinated wheat, potato flour, dogtooth violet starch and the like. The starch powder includes, for example, wheat starch, potato starch, tapioca starch, corn starch, rice starch, and processed starch, which may be used by appropriately combining with the cereal flour described above. One or more of these flours may also be combined.

According to the preferred embodiment of the present invention, the cereal flour is at least one selected from the group consisting of wheat flour, soy flour, rice flour, cornstarch and bean curd lees powder. More preferably, it is wheat flour. Among the cereal flours, when a flour having poor bonding strength such as bean curd lees powder or dogtooth violet starch is used, it is desirable to use the flour in combination with wheat flour.

### Oil or Fat Component

In the present invention, the oil or fat component is not specifically limited if it is an edible one which is generally provided for baked foods and may be any one of vegetable fat or oil, animal fat or oil, and processed fat or oil. Specifically, the fat or oil component includes, for example, vegetable oils such as rapeseed oil, soybean oil, corn oil, copra oil, palm oil, safflower oil, cottonseed oil, sesame oil, olive oil, camellia oil, rice oil and coconut oil, butter, lard, beef tallow, lard, avian fat, egg oil, fish oil, margarines, shortenings and the like. These can be used as a combination of one or more. In eggs, the edible part contains an oil or fat component in an amount of about 10%, and the oil or fat component contained in the egg can be used in the case of combining larger amount of the egg.

The oil or fat component in the present invention preferably includes at least one selected from the group consisting of butter, shortening and margarine.

### Emulsifying Component

In the present invention, the emulsifying component is not specifically limited if it is the one which is generally provided for emulsification and includes, for example, egg, lecithin (preferably, egg yolk lecithin), lecithin derivatives such as lysolecithin, saponin, glycerine fatty acid esters, sucrose fatty acid esters, sorbitan fatty acid esters, propylene glycol fatty acid esters and the like. One or more of these emulsifying components may also be combined.

The emulsifying component in the present invention is preferably an egg or lecithin.

### Blending Amount

In the present invention, the content of astaxanthin in the baked food produced from dough may be in the range that the baked food produced from dough can hold the form of the food, generally in the range that astaxanthin will not exude and specifically in the range that astaxanthin can be uniformly added, and, for example, the astaxanthin can be blended into a food ingested in a meal in an amount of about 0.01 mg to 100 mg in total. The blending amount of astaxanthin is defined to the total amount of a cereal flour, an oil or fat component and optionally an emulsifying component, and the blending ratio (based on weight) is in a proportion of the total amount:astaxanthin=100:0.0001 to 1, preferably 100:0.0005 to 0.1, more preferably 100:0.01 to 0.05.

In the present invention, the blending ratio (based on weight) of the cereal flour and the fat or oil component in the baked food produced from dough is in a proportion of the cereal flour:the fat or oil component=100:0.1 to 150, preferably the cereal flour:the fat or oil component=100:1 to 100, more preferably the cereal flour:the fat or oil component=100:10 to 50.

In the present invention, the blending amount of the flour is typically in the range of 10 to 80 parts by weight to 100 parts by weight of the total weight of the baked food produced from dough, preferably in the range of 20 to 60% by weight, and more preferably 25 to 50% by weight.

In the present invention, the content of the emulsifying component in the baked food produced from dough is defined to the cereal flour, and the blending ratio (based on weight) is in a proportion of the cereal flour:the emulsifying component=100:0.1 to 10, preferably the cereal flour:the emulsifying component=100:0.5 to 8, and more preferably the cereal flour:the emulsifying component=100:1 to 6. In the case of blending the egg, the blending ratio is based on a phospholipid contained in the raw egg. For example, while the egg contains proteins in addition to the phospholipids and the contents of these components depend on the production conditions of the eggs, the blending ratio is in a proportion of the cereal flour:raw egg=100:1 to 100, preferably the cereal flour:raw egg=100:5 to 80, more preferably the cereal flour:raw egg=100:10 to 60.

### Other Components

The baked food produced from dough according to the present invention may further contain sugar components in order to give sweetness and flavor to the food and to improve the bonding of starch particles and the preparation of dough.

As the sugar components are included, for example, monosaccharides such as fructose and glucose, sucrose, disaccharides such as maltose and oligosaccharides, and furthermore reduced derivatives of these saccharides, for example, sugar alcohols are also regarded to be included. The sugar alcohols include, for example, sorbitol, xylitol, mannitol, erythritol, maltitol, lactitol, and the like. These sugar alcohols may be used in combination of the two or more.

When the sugar components are added in the present invention, the content of the sugar components in the baked food is defined to the amount of a flour, and the blending ratio (based on weight) is, for example, in a proportion of the flour:sugar=100:0.1 to 120, preferably the flour:sugar=100:1 to 80, more preferably the flour:sugar=100: 2 to 50.

The baked food produced from dough of the present invention may further comprise as the other components perfumes, colorants, seasoning components, stabilizers, leavening agents, baking soda, baking powder, antioxidants and the like.

Among them, the seasoning component include cocoa powder, condensed milk, fresh cream, yoghurt powder, cheese, chocolate, cacao mass, sesame, herbs, fruit juices, vegetable juices, dry fruit powder, fruit pieces, powdered green tea, spices, nuts, salt, and the like.

The antioxidant, which is not specifically limited if it is the one having antioxidant effects, may be blended, and at least one can be selected from the group consisting of, for example, vitamin A such as retinol and 3,4-didehydroretinol; vitamin B; vitamin C such as D-ascorbic acid and L-ascorbic acid; vitamin E such as tocopherol, tocotrienol, vitamin E acetate, vitamin E succinate and vitamin E phosphate; carotenoids such as β-carotene and lutein, and pharmaceutically acceptable salts thereof; coenzyme Q, flavonoids, tannin, ellagic acid, polyphenols, nucleic acids, Chinese herbal medicines, seaweeds, minerals, and mixtures thereof. Similar effects can also be obtained by blending fruits, seaweeds and bacteria containing these antioxidants.

In the baked food produced from dough of the present invention, nutrient enrichment components other than astaxanthin may also be added. The nutrient enrichment components include, for example, calcium components, iron, vitamins and dietary fibers.

The forms of the baked food produced from dough of the present invention include baked cake bar, biscuit, cookie, macaron, tuile, sponge cake, chiffon cake, pancake, soufflé, pie, nan, bread, bagel, cream puff, chips, snack food, rice cracker, Sokasenbei, steamed yeast bun with filling, Oyaki, Gohei-mochi and the like. Food forms in which cream or the like is inserted or contained are also included in the forms of the baked food produced from dough of the present invention.

### Structure of Baked Food Produced From Dough

The baked food produced from dough of the present invention has a structure for holding an oil or fat component containing astaxanthin in a spongy structure formed from the starch of a cereal flour, and has a porosity in the range of 10 to 70%

In this connection, the term “a spongy structure formed from the starch of a cereal flour” means a structure that in the matrices composed of starch particles derived from flour, pregelatinized starch, proteins derived from flour, proteins derived from egg and sugar, the starch particles derived from flour are bonded by bonding components such as pregelatinized starch, proteins derived from flour, proteins derived from egg and sugar and form hollows within the baked food. In addition, if the baked food has such spongy structure described above, the diameter between the matrices is typically in the range of 10 to 500 pm, preferably 20 to 300 pm. Furthermore, in a baked food having such spongy structure, the weight per unit, that is, the porosity is typically in the range of 10 to 70%, preferably 20 to 70%, more preferably 30 to 60%, more preferably 30 to 50%.

In this connection, the porosity can be specifically obtained by subtracting the true volume based on the true density from the apparent volume of the food, dividing the difference with the apparent volume and expressing the quotient by percentage. In the more strict definition, the porosity is the value obtained by subtracting the actual density obtained by compression from the density of the food, dividing the difference with the apparent volume and expressing the quotient by percentage. The density of the food is obtained by dividing the volume with the weight. The volume may be measured by any method generally used, and for example, by the methods for measuring the volume with a three-dimensional radar volumeter or by cutting the food into cubes. The density obtained by compression is measured with an apparatus such as a tablet compression tester which can measure compression, volume or weight. In the measurement, the pressure applied for compression is the one by which the food is compressed almost to the minimum volume, and the pressure can be changed according to the softness of the food. The ordinary foods are compressed at a pressure of 100 kgf, and the foods which will be liquefied by compression are compressed at a pressure of 50 kgf or 20 kgf.

In addition, the spongy structure and hollow diameter of the baked food can be confirmed and measured microscopically (preferably with a scanning electron microscope).

Thus, the baked food produced from dough of the present invention desirably has “a structure for holding an oil or fat component containing astaxanthin in a spongy structure formed from the starch of a cereal flour.”

It can be confirmed microscopically (preferably with a scanning electron microscope) as described above that the baked food has such a structure as described above.

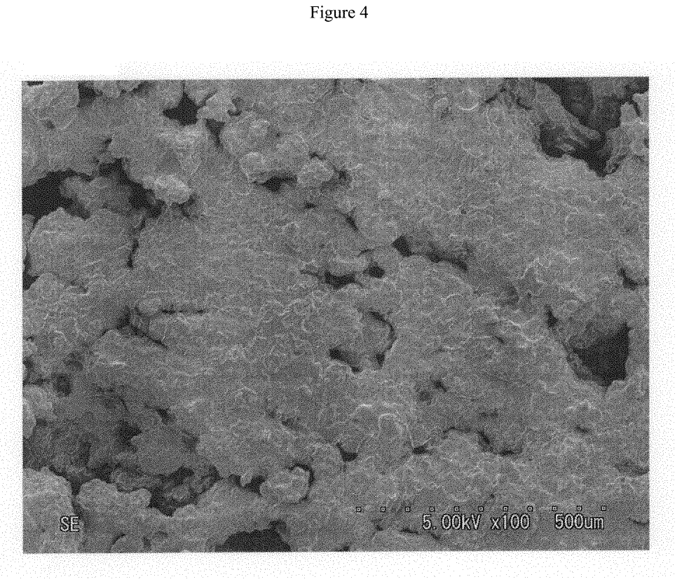

The specific example of such structure is illustrated by the structure of the photomicrograph (FIG. 4) taken in the example described later. In this case, the photograph illustrates a structure which holds an oil or fat component in which astaxanthin is dissolved in matrices composed of starch particles derived from flour, pregelatinized starch, protein derived from flour, protein derived from egg and sugar, and oil droplets in which astaxanthin is covered with the emulsifying component.

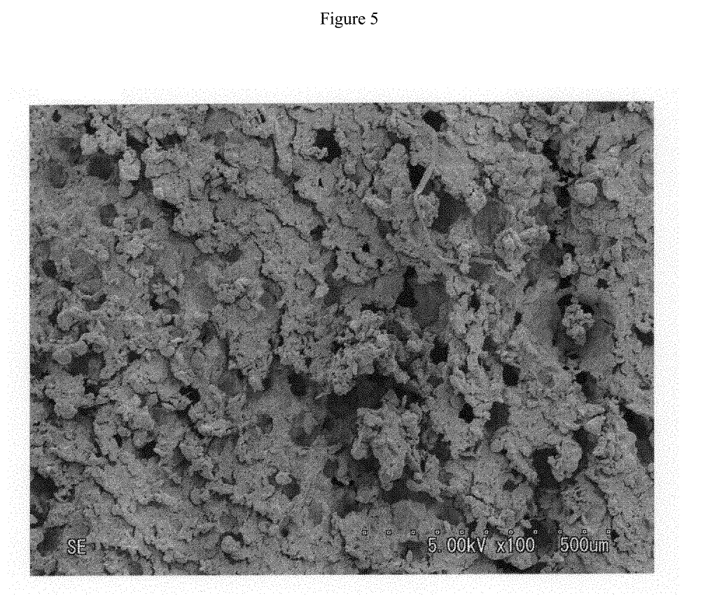

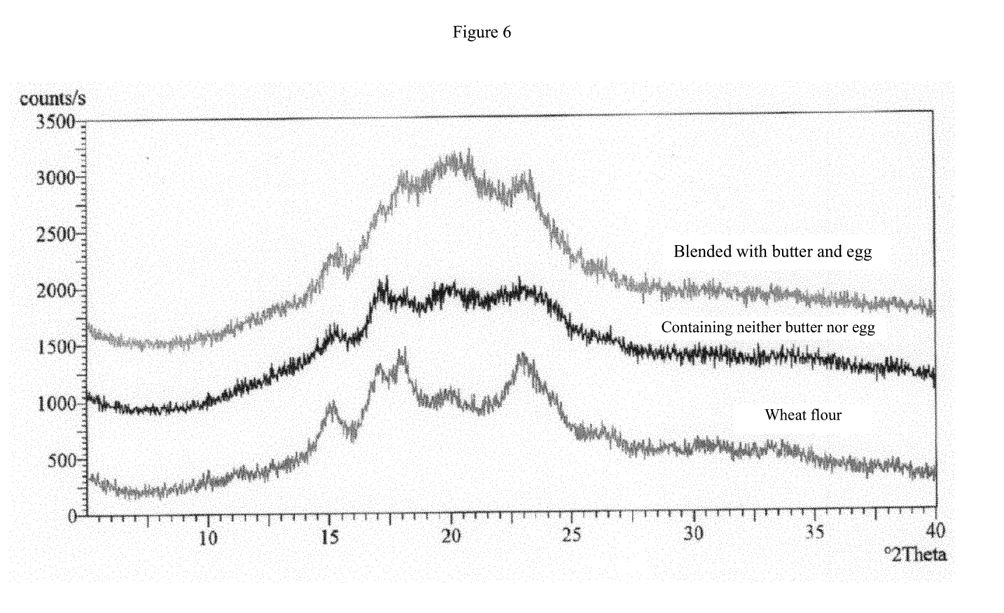

In this connection, the structure of the photomicrograph (FIG. 5) taken in the example shows the state containing neither astaxanthin nor its oil droplets, and shows the spongy structure from this photomicrograph. It can be speculated by obtaining the chrystal patterns (e.g., FIG. 6 of the example), of which results (in the case of FIGS. 4 and 5) are almost the same and similar to the pattern of the starch derived from the flour that the structure of the baked food produced from dough of the present invention (FIG. 4) includes the structure of FIG. 5.

Hence, the baked food produced from dough of the present invention has the long term stability of astaxanthin and thus has a form capable of long term preservation. The form capable of long term preservation is a food in which the weight per unit, i.e., the porosity is low as described above and the shape of the food has a strength sufficient for bearing the change on lamination.

### Method for Preparing Baked Food Produced From Dough

The baked food produced from dough of the present invention comprises, as described above, astaxanthin, a cereal flour, an oil or fat component, optionally an emulsifying component as the major components, and the aimed baked food can be obtained by the following steps:

(i) the dough is prepared by blending and thoroughly kneading the major components so that the astaxanthin is uniformly dispersed in the mixture of the major components, and then

(ii) the dough is baked.

Oil droplets containing astaxanthin are formed in the dough by kneading the mixture in the step (i) and are dispersed uniformly in the dough. The dough is baked in the next step (ii) to remove water, and thus “the structure which holds an oil or fat component containing astaxanthin in the spongy structure formed from the starch of a cereal flour” can be formed in the aimed baked food.

In the method for producing the dough, the dough is generally prepared according to the method for producing a baked food comprising a cereal flour. Astaxanthin, an oil or fat component, an emulsifying component, a cereal flour, optionally the other components such as sugar may be added in any order if only kneading can be uniformly conducted. In the baked food of a cereal flour, food feelings such as texture and taste will be changed by the orders of adding the raw materials, the addition order may be followed to the addition order in the aimed form of a food. Astaxanthin may also be added in any step ranging from the first to the last steps. This is because the dough is an O/W emulsion and astaxanthin added is immediately dissolved in an oil or fat component.

The flour releases starch and protein by kneading in the presence of water. An emulsion comprising a continuous phase of the bonding agents such as aqueous starches, proteins and sugar and droplets of an oil or fat component is formed by the presence of the oil or fat component. It is believed that the spongy structure is formed by removing water in the continuous phase on baking the emulsion (in this connection, these descriptions are only a theoretical speculation and the present invention will not be limited thereby).

Thus, the ratio of a cereal flour and water on the preparation of dough is important in order to form a moderate “spongy structure” in the baked food of the present invention. If the amount of water is excessive, the progress of dissolution or the deterioration of structure due to the pregelatinization of the starch particles is unfavorably caused. The ratio of the cereal flour to water (based on weight) in the mixture of the raw materials is typically in the range of 100:5 to 150, preferably 100:5 to 100. If the ratio of the cereal flour to water is 100:150, the dough is liquefied unfavorably.

Hence, according to a preferred embodiment of the present invention, a baked food produced from dough can be obtained by preparing the dough by mixing and sufficiently kneading the mixture of major components containing astaxanthin, a cereal flour, an oil or fat component, optionally an emulsifying component so as the astaxanthin to be uniformly dispersed, in which the ratio of the cereal flour and water is set as described above, and then by baking the dough.

By way of example, when a flour food in the form of biscuit is produced, astaxanthin and an oil or fat component are blended, then sugar and egg are blended in this order to form a homogeneous mixture, to which wheat flour is slowly added and kneaded homogeneously, and dough is produced by holding it at a low temperature for dispersing water homogeneously.

When a food in the form of bread is produced, wheat flour, water, baking powder and the like are kneaded, astaxanthin dissolved in a shortening is added, and after kneading, fermented to produce dough.

The dough is adjusted to a shape corresponding to the food, and all it takes is baking at a temperature in which water can be timely removed. The temperature of baking is in the range of 100 to 250° C., preferably 120 to 220° C. Baking time can be appropriately selected and is in the range of 2 to 60 minutes, preferably 10 to 30 minutes. The component having antioxidative effect is easily affected by heat and requires, if possible, low temperature and short time, but the baked food produced from dough of the present invention can be produced under the ordinary production condition. Baking may be conducted either with the molded dough or with the dough left in the mold.

The other components such as seasoning components may also be blended in any step at the preparation of dough. The blending step may appropriately selected by an easy condition. For example, when dry fruits or nuts are blended, astaxanthin, butter, sugar and egg are blended in this order before adding and mixing the dry fruits and nuts, and then soy flour or wheat flour is added for kneading. After the dough is fermented, it is baked at 160° C. for 15 minutes.

### EXAMPLES

The present invention is specifically described below with reference to the examples of the present invention. The present invention is not limited to these examples.

### Method for Measuring the Content of Astaxanthin

After an astaxanthin-containing sample is ground in a mortar and the astaxanthin is extracted with acetone, the content of astaxanthin was obtained by measuring the absorbance at a wave length of 474 nm with a self-recording spectrophotometer (made by Shimadzu Corporation). After oily AstaReal 50F was diluted with acetone, the absorbance was measured in the same manner.

The content of astaxanthin after baking (residual ratio) was calculated to the theoretical value of 100% on the basis of the charged amount. The content of astaxanthin (residual ratio) in a long term test was calculated to the astaxanthin content immediately after baking of 100%.

### Example 1

### Long Term Stability Test of the Baked Food Produced From Dough and Chocolate Containing Astaxanthin

### (1) Baked Food Produced From Astaxanthin-Containing Dough

After 0.226 g of astaxanthin, 35 g of butter, 30 g of sugar and 25 g of egg were added in this order and homogeneously mixed, 100 g of weak flour (wheat flour) was added and kneaded homogeneously, After holding the mixture at 4° C. for 30 minutes, it was extended to a thickness of 5 mm, shaped with a disk mold, and baked at 170° C. for 16 minutes to give a baked food produced from dough. As the astaxanthin, an oil extract of astaxanthin (AstaReal 50F, Fuji Chemical Industry Co., Ltd.; containing about 5% of astaxanthin in the form of free astaxanthin) or Hematococcus biomass (BioReal (Sweden) AB; containing about 5% of astaxanthin in the form of free astaxanthin) was used. The baked food produced from dough containing the oil extract of astaxanthin had a porosity of 26%.

In this connection, the porosity in this example was calculated as described below.

The baked food produced from dough thus obtained had a weight of 14.8 g and a volume of 16.0 cm³, so that the apparent density was 0.93 g/cm³. On the other hand, the components of the raw materials were classified again as starch, lipids, proteins, sucrose, astaxanthin and water, respectively, for conversion, and the theoretical true density (g/cm³) was calculated from the contents of the respective components. It was found from the total amount that the baked food produced from dough had a theoretical true density of 1.26 g/cm³. The porosity was calculated from the values obtained according to the following equation:

$$\begin{matrix}Porosity = & ( theoretical true density - \\ & apparent density ) / theoretical true density \times 100 \\ = & ( 1.26 - 0.93 ) / 1.26 \times 100 \\ = & 26.2 ( \% )\end{matrix}$$

### (2) Astaxanthin-Containing Chocolate

200 g of chocolate was melted by warming to 45° C., then cooled to 30° C., and after adding and mixing with 1.2 g of the oil extract of astaxanthin, solidified by cooling to give astaxanthin-containing chocolate.

### (3) Long Term Stability Test

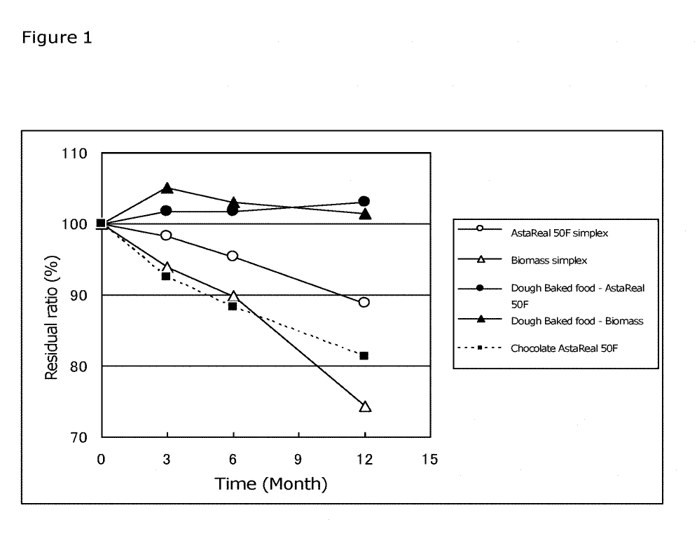

The baked food produced from dough and chocolate thus obtained, the oil extract of astaxanthin, and hematococcus biomass were sealed in plastic bags and stored in darkness at 25° C. The samples were taken out at the predetermined time of the storage period, and the amounts of astaxanthin contained in the samples were measured. The results are shown in Table 2 and FIG. 1.

TABLE 1
Residual ratio of astaxanthin after baking (%)

| | Residual ratio |
|---|---|
| AstaReal 50F | 72.7 |
| The baked food produced from dough | 101.4 |
| (containing AstaReal 50F) | |
| Biomass simplex | 41.4 |
| The baked food produced from dough | 103.1 |
| (containing biomass) | |

TABLE 2
Residual ratio of astaxanthin in long term storage test (%)

| | 3 Months | 6 Months | 12 Months |
|---|---|---|---|
| AstaReal 50F | 98.2 | 95.3 | 88.9 |
| The baked food produced from dough | 101.8 | 101.2 | 103.1 |
| (containing AstaReal 50F) | | | |
| Chocolate | 92.4 | 88.3 | 81.3 |
| (containing AstaReal 50F) | | | |
| Biomass | 93.9 | 89.8 | 74.4 |
| The baked food produced from dough | 105.1 | 103.0 | 101.5 |
| (containing biomass) | | | |

Table 1 shows that astaxanthin contained in the oil extract of astaxanthin and the biomass was decomposed by baking and the residual ratios were decreased. In contrast, astaxanthin blended in the baked food produced from dough is not decreased after baking.

Table 2 shows that the content of astaxanthin was decreased with the passage of time in the oil extract of astaxanthin and the chocolate containing the biomass. In contrast, the content of astaxanthin was not significantly decreased in the baked foods produced from dough of the present invention containing the oil extract of astaxanthin or the biomass even after 12 months. It was expected that the chocolate includes astaxanthin within the fat or oil component, and thus has no vacant spaces, little specific surface area and high oxidation stability, while the baked food produced from dough has many vacant spaces within the food, large specific surface area and low oxidation stability, but opposite results were obtained.

### Example 2

### Stability Test on the Other Carotenoids

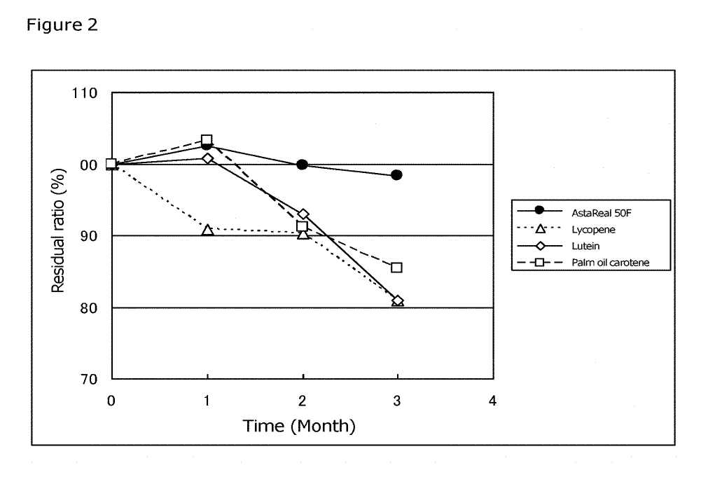

Baked kneaded foods were obtained in the same procedure as the baked food produced from astaxanthin-containing dough in Example 1 except using the carotenoid oil extracts in Table 6. As the carotenoid oil extracts, lycopene and lutein were used. Both of these compounds are in the form of the oil extract and lipophilic like that of astaxanthin. Table 3 shows the residual ratio of astaxanthin, and Table 4 and FIG. 2 show the results of long term stability test.

TABLE 3
Residual ratio of carotenoid after baking (%)

| | After Baking |
|---|---|
| AstaReal 50F | 108.5 |
| Lycopene | 109.1 |
| Lutein | 109.8 |
| Palm oil carotene | 100.2 |

TABLE 4
Residual ratio of carotenoids in long term test

| | 1 Month | 2 Months | 3 Months |
|---|---|---|---|
| AstaReal 50F | 102.5 | 99.8 | 98.4 |
| Lycopene | 90.9 | 90.3 | 81.0 |
| Lutein | 100.8 | 93.0 | 81.0 |
| Palm oil carotene | 103.2 | 91.2 | 85.4 |

No difference was observed for the stabilities of carotenoids by baking. In the long term stability test, carotenoids other than astaxanthin such as lycopene, lutein and palm oil carotene had an inferior stability in the range of 90% or less. In addition, the stability tends to decrease, so that the residual ratio is expected to be lowered by holding further for a long period of time. It is understood that only astaxanthin has the stability effect when made up in the form of the baked food produced from dough of the present invention.

### Example 3

### Validation Test of Butter and Egg

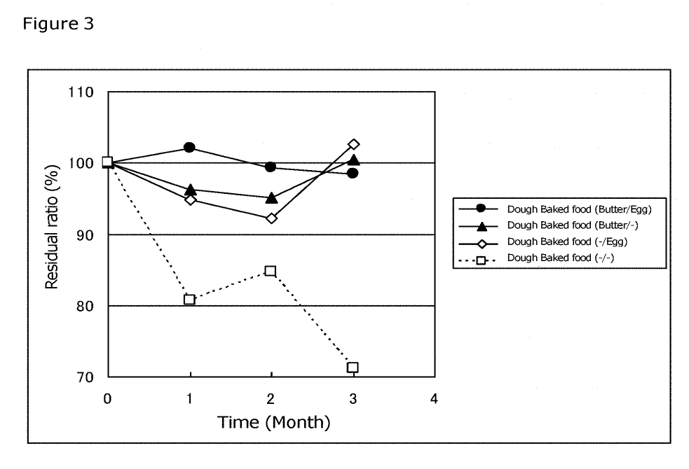

Baked foods produced from dough containing no butter and/or egg were obtained in the same procedure as the baked food produced astaxanthin-containing dough. The dough containing no butter and/or egg was kneaded with an appropriate amount of water. The residual ratios of astaxanthin immediately after baking are shown in Table 5, and the residual ratios of astaxanthin in the long term stability test were shown in Table 6 and FIG. 3.

The scanning electron micrograph (S-3000N, Hitachi, Ltd.) of the baked food produced from dough containing butter and egg is shown in FIG. 4, and of the baked food produced from dough containing neither butter nor egg is shown in FIG. 5. Further, the X-RD charts (X′Pert-MPD; Philips) of the baked food produced from dough containing butter and egg and containing neither butter nor egg are shown in FIG. 6.

TABLE 5
Residual ratio of astaxanthin after baking (%)

| Sample | After baking |
|---|---|
| Baked food produced from dough (butter/egg) | 99.5 |
| Baked food produced from dough (butter/—) | 95.0 |
| Baked food produced from dough (—/egg) | 92.1 |
| Baked food produced from dough (—/—) | 65.3 |

TABLE 6
Residual ratio of astaxanthin in long-term test (%)

| | 1 | 2 | 3 |
|---|---|---|---|
| Sample | Month | Months | Months |
| Baked food produced from dough | 102.0 | 99.3 | 98.4 |
| (butter/egg) | | | |
| Baked food produced from dough (butter/—) | 96.3 | 95.1 | 100.5 |
| Baked food produced from dough (—/egg) | 94.8 | 92.2 | 102.7 |
| Baked food produced from dough (—/—) | 80.7 | 84.7 | 71.1 |

The baked foods produced from dough containing butter as the fat or oil component and/or egg as the emulsifying component had the residual ratios of astaxanthin both on baking and in the long-term preservation in the range of 90% or more thus showing good stability. In contrast, the baked food produced from dough containing neither butter nor egg had the residual ratios of astaxanthin of 80% thus showing low stability.

The high stability of astaxanthin in the baked food produced from dough of the present invention is believed due to the structure in which, as is clear from the electron micrograph and the X-RD, the spongy structure of starch is formed and the fat or oil component containing astaxanthin is inscribed within the vacant spaces. The baked food containing neither butter nor egg shows the microphotograph in the spongy form in which spherical particles are bonded by the bonding materials. While the interior structure remains ambiguous in the microphotograph of the baked food containing neither butter nor egg, which shows the same X-RD pattern as the baked food containing butter and egg, it is understood that the similar structures have been formed within the baked foods.

### Example 4

### Effect of the Blending Amount of Butter

Baked foods produced from dough were obtained in the similar procedure to the baked food produced from astaxanthin-containing dough except no egg (0 g) was blended and the various amounts of butter shown in Table 7 were blended. If kneading was difficult due to the absence of a water component such as egg, an appropriate kneadable amount of water was slowly added optionally in order to knead uniformly the blend. The residual ratios of astaxanthin after baking are shown in Table 7.

TABLE 7
Residual ratio of astaxanthin after baking (%)

| | After |
|---|---|
| Sample | baking |
| Baked food produced from dough (0 g of butter/0 g of egg) | 65.3 |
| Baked food produced from dough (1 g of butter/0 g of egg) | 91.0 |
| Baked food produced from dough (10 g of butter/0 g of egg) | 94.7 |
| Baked food produced from dough (35 g of butter/0 g of egg) | 95.0 |
| Baked food produced from dough (75 g of butter/0 g of egg) | 94.4 |
| Baked food produced from dough (100 g of butter/0 g of egg) | 92.5 |

It is understood that the stabilities of astaxanthin have been improved by the addition of butter as an oil or fat component as will be confirmed from that the residual ratio of astaxanthin after baking is 90% or more. In contrast, the stability of astaxanthin remained in a low level in the baked food produced from dough containing no butter as will be shown from that residual ratio of astaxanthin was 65.3%.

### Example 5

### Effect of the Blending Amount of an Emulsifying Component

Baked foods produced from dough were obtained in the similar procedure to the baked food produced from astaxanthin-containing dough except no butter (0 g) was blended and the various amounts of egg shown in Table 8 were blended. If kneading was difficult due to the absence of a water component such as egg, an appropriate kneadable amount of water was slowly added optionally in order to knead uniformly the blend. The residual ratios of astaxanthin after baking are shown in Table 8.

TABLE 8
Residual ratio of astaxanthin after baking (%)

| | After |
|---|---|
| Sample | baking |
| Baked food produced from dough (0 g of butter/0 g of egg) | 65.3 |
| Baked food produced from dough (0 g of butter/1 g of egg) | 82.3 |
| Baked food produced from dough (0 g of butter/10 g of egg) | 87.1 |
| Baked food produced from dough (0 g of butter/25 g of egg) | 92.1 |
| Baked food produced from dough (0 g of butter/60 g of egg) | 100.0 |
| Baked food produced from dough (0 g of butter/100 g of egg) | 98.4 |

It is understood that the effect for stabilizing astaxanthin is high if a large amount egg such as 25 g or more is blended. The egg is composed of lecithin, proteins and lipids having emulsification effects, and the stability is provoked by the increased amounts of these components.

### Example 6

### Effects of Flours and Emulsifying Components

Baked foods produced from dough were obtained in the similar procedure to the baked food produced from astaxanthin-containing dough except the flours and emulsifying components shown in Table 9 were employed. The residual ratios of astaxanthin immediately after baking are shown in Table 9, and the residual ratios of astaxanthin in the long-term stability test are shown in Table 10. In this connection, the bean curd lees powder is a mixture of a commercially available bean curd lees powder and weak flour in a ratio of 1:2.

TABLE 9
Residual ratio of astaxanthin after baking (%)

| | Emulsifying | |
|---|---|---|
| Flour | component | After baking |
| Weak flour | Egg | 101.4 |
| Soy flour | Egg | 106.4 |
| Bean curd lees powder | Egg | 105.3 |
| Dogtooth violet starch | Egg | 100.9 |
| Cornstarch | Egg | 98.9 |
| Weak flour | Lecithin | 100.5 |
| Soy flour | Lecithin | 93.3 |
| Bean curd lees powder | Lecithin | 100.5 |

TABLE 10
Residual ratio of astaxanthin in long-term test (%)

| | Emulsifying | | | |
|---|---|---|---|---|
| Flour | component | 1 Month | 2 Months | 3 Months |
| Weak flour | Egg | 108.8 | 103.4 | 103.3 |
| Soy flour | Egg | 101.4 | 94.3 | 95.3 |
| Bean curd lees powder | Egg | 102.0 | 107.7 | 109.9 |
| Weak flour | Lecithin | 104.0 | 101.0 | 100.1 |
| Soy flour | Lecithin | 104.5 | 93.3 | 97.2 |
| Bean curd lees powder | Lecithin | 104.3 | 104.6 | 101.8 |

The astaxanthin contained in the baked food produced from dough of the present invention was stable even if a variety of flours or emulsifying components were employed. It is understood that any flour or emulsifying component is effective irrespective of its kinds.

Baked foods produced from dough were obtained in the similar procedure to the baked food produced from astaxanthin-containing dough except the fat or oil components shown in Table 11 were employed. The residual ratios of astaxanthin immediately after baking are shown in Table 11.

TABLE 11
Residual ratio of astaxanthin after baking (%)

| Sample | After baking |
|---|---|
| Baked food produced from dough (butter) | 99.5 |
| Baked food produced from dough (shortening) | 107.6 |
| Baked food produced from dough (salad oil) | 97.5 |
| Baked food produced from dough (olive oil) | 96.3 |
| Baked food produced from dough (MCT) | 96.5 |
| Baked food produced from dough (BALLADE) | 100.5 |

The astaxanthin contained in the baked food produced from dough of the present invention was stable even if a variety of fat or oil components were employed. It is understood that any fat or oil component is effective irrespective of its kinds.

### Example 7

### Effect of Baked Foods Having Different Porosities

### (1) Preparation of Baked Foods a to e Baked Food a:

After 0.226 g of astaxanthin, 35 g of butter and 30 g of sugar were added in this order and blended homogeneously, 100 g of weak flour (wheat flour) was added and kneaded uniformly. After holding the mixture at 4° C. for 30 minutes, it was extended to a thickness of 5 mm, shaped with a disk mold, and baked at 170° C. for 16 minutes to give a baked food produced from dough.

### Baked Food b:

After 0.226 g of astaxanthin, 35 g of butter, 30 g of sugar and 25 g of egg were added in this order and uniformly blended, 100 g of weak flour (wheat flour) was added and kneaded uniformly. After holding the mixture at 4° C. for 30 minutes, it was extended to a thickness of 5 mm, shaped with a disk mold, and baked at 170° C. for 16 minutes to give a baked food produced from dough.

### Baked Food c (Hard Baked Product (High Density)) (Comparative Example):

After 0.226 g of astaxanthin, 10 g of butter, 60 g of sugar, 10 g of egg and 24 g of water were added in this order and blended homogeneously, 100 g of weak flour (wheat flour) was added and kneaded uniformly. After holding the mixture at 4° C. for 30 minutes, it was extended to a thickness of 5 mm, shaped with a disk mold, and baked at 170° C. for 16 minutes to give a baked food produced from dough (hard baked product).

### Baked Food d (Soft Baked Product):

After 0.226 g of astaxanthin, 35 g of butter, 30 g of sugar, 75 g of egg and 4.3 g of baking powder were added in this order and blended homogeneously, 100 g of weak flour (wheat flour) was added and kneaded uniformly. After holding the mixture at 4° C. for 30 minutes, it was extended to a thickness of 5 mm, shaped with a disk mold, and baked at 170° C. for 16 minutes to give a baked food produced from dough (soft baked product).

### Baked Food e (Chiffon Cake):

After mixing 64.3 g of egg yolk and 42.9 g of sugar, 42.9 g of salad oil, 0.226 g of astaxanthin, 42.9 g of water and 2.1 g of baking powder were blended to form dough. After mixing 171.4 g of egg yolk and 57.1 g of sugar, the mixture was strongly stirred to prepare meringue. The dough and meringue were mixed, put in a mold, and baked at 170° C. for 30 minutes to give chiffon cake.

### (2) Measurement of Porosity

As regards the respective preparation examples shown in Table 12, the weights and volumes of the samples before test and after compression, respectively, were measured to obtain densities, and the porosities were calculated according to the following equation:

Porosity=(Density before test−Density after compression)/Density before test×100

### Method for Measuring Density Before Test:

After measuring the weight of the sample, the volume was measured with a radar volumeter (High-speed three-dimensional volume-shape measuring apparatus SELNAC-VM150; Astex Research & Development Co., Ltd.). The volume was divided with the weight to give the density before test.

### Method for Measuring Density After Compression:

A sample was pulverized in a mortar, and the weight was measured. To the sample was applied a pressure of 100 kgf with a tableting tester (SK-2; Sankyo Pio-Tech Co., Ltd.) to eliminate vacant spaces, and the volume was measured. The volume was divided with the weight to give the density after test. In this connection, liquefaction was observed in the soft baked product and chiffon cake, to which were applied the pressures of 50 kgf and 20 kgf, respectively, as the lower limits of liquefaction for measurement.

The results are shown in the table below.

TABLE 12
Porosity of baked foods

| | | | Porosity | Pressure |
|---|---|---|---|---|
| Sample | | Astaxanthin | (%) | [kgf] |
| Baked food a | 35 g of Butter, | 95.0 | 27.8 | 100 |
| | 0 g of egg | | | |
| Baked food b | 35 g of Butter, | 101.4 | 30.2 | 100 |
| | 25 g of egg | | | |
| Baked food c | 10 g of Butter, | 76.8 | 8.6 | 100 |
| (Hard baked | 10 g of egg | | | |
| product) | | | | |
| Baked food d | 35 g of Butter, | 91.6 | 63.7 | 50 |
| (Soft baked product) | 75 g of egg | | | |
| Baked food e | 43 g of salad oil | 92.3 | 67.9 | 20 |
| (Chiffon cake) | 236 g of egg, | | | |
| | 100 g of sugar | | | |

1. A baked food produced from dough, which is capable of stably holding astaxanthin therein for a long period,
comprising a cereal flour, an oil or fat component and astaxanthin,
wherein the baked food product has having a porosity in the range of 20 to 50%, and
wherein the baked food product is capable of holding astaxanthin therein in an amount of 94% by weight or more when stored at room temperature for a period of at least 3 months as compared to the astaxanthin content in the food immediately after baking.

2. A baked food produced from dough according to claim 1, which further comprises an emulsifying component.

3. (canceled)

4. A baked food produced from dough according to claim 1, wherein the astaxanthin is any one of an oil extract of astaxanthin, an cell wall debris of algae hematococcus or a yeast phaffia debris.

5. A baked food produced from dough according to claim 1, wherein the cereal flour is at least one selected from the group consisting of wheat flour, soy flour, rice flour, corn flour, barley flour, rye flour, oat flour, potato flour, bean curd lees powder and cornstarch.

6. A baked food produced from dough according to claim 1, wherein the oil or fat component is at least one selected from the group consisting of butter, shortening, margarine, lard, egg oil, rapeseed oil, soybean oil, corn oil, copra oil, palm oil, safflower oil, cottonseed oil, sesame oil, olive oil, camellia oil, rice oil and coconut oil.

7. A baked food produced from dough according to claim 1, wherein the emulsifying component is at least one selected from the group consisting of egg, lecithin, lysolecithin, saponin, glycerine fatty acid ester, sucrose fatty acid ester, sorbitan fatty acid ester and propylene glycol fatty acid ester.

8. A baked food produced from dough according to claim 1, wherein the blending ratio (based on weight) of a cereal flour and an oil or fat component is in the range of the cereal flour: the oil or fat component=100:0.1 to 150.

9. A baked food produced from dough according to claim 1, wherein the blending ratio (based on weight) of a cereal flour and an emulsifying component is in the range of the cereal flour:the emulsifying component=0.1 to 10.

10. A baked food produced from dough according to claim 1, wherein the blending ratio (based on weight) of astaxanthin to the total amount of a cereal flour, an oil or fat component and an emulsifying component is in the range of 100:0.0001 to 1.

11. A baked food produced from dough according to claim 1, which has a structure for holding an astaxanthin containing oil or fat component in voids having a spongy structure formed from starch of a cereal flour.

12. A method for preparing a baked food produced from dough according to claim 1, which comprises astaxanthin, a cereal flour, an oil or fat component and optionally an emulsifying component as the major components, and is capable of stably holding astaxanthin therein for a long period, wherein the dough is prepared by blending and thoroughly kneading the major components so that the astaxanthin is uniformly dispersed in the mixture of the major components, and then the dough is baked.
